(19) United States
(12) Patent Application Publication
(10) Pub. No.: US 2016/0232510 A1
(43) Pub. Date: Aug. 11, 2016

(54) CHECKOUT APPARATUS AND METHOD FOR PRESENTING CANDIDATE MERCHANDISE

(71) Applicant: TOSHIBA TEC KABUSHIKI KAISHA, Tokyo (JP)

(72) Inventor: Tetsuya SADOWARA, Mishima Shizuoka (JP)

(21) Appl. No.: 14/614,572

(22) Filed: Feb. 5, 2015

(51) Int. Cl. G06Q 20/20; G06T 11/60; G07G 1/01; G06K 9/62; G07G 1/00; G07G 1/12

(52) U.S. Cl. CPC G06Q 20/208; G07G 1/0036; G07G 1/12; G07G 1/01; G07G 1/0009; G06K 9/6215; G06T 11/60; G06T 2210/32

(57) ABSTRACT

A checkout apparatus includes an imaging unit configured to convert an image of an item to be purchased into image data, a processing unit configured to determine one or more items for sale as candidates, based on the generated image data and image data of items for sale that have been previously registered, and a display unit configured to display information indicating the candidates. When the processing unit determines as candidates a first candidate that has a first similarity value and a second candidate that has a second similarity value that indicates less similarity than the first similarity value, the display unit displays the information indicating the first candidate and the information indicating the second candidate in a same format if a difference between the first and second similarity values is smaller than a predetermined value, and in different formats if the difference is greater than the predetermined value.

### FIELD

Embodiments described herein relate generally to a checkout apparatus and a method for presenting candidate merchandise to be purchased in a purchase transaction.

### BACKGROUND

Recently, checkout of an item to be purchased in stores, such as a supermarket, is generally carried out using a checkout system (POS system). A conventional checkout system identifies the item based on a code (such as barcode) put on the item. Another checkout system identifies the item based on an image of the item captured by the checkout system. Specifically, such a checkout system generates image data of the item based on the captured image and compares the image data with image data of items for sale that are registered in the checkout system in advance. Then, one or more items for sale that have high similarity to the item to be purchased are determined to be candidates, and the candidates are presented on a display device. When two or more candidates are presented, a user of the checkout system needs to select one of the candidates as the item to be purchased.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 illustrates a checkout system (POS system).

FIG. 2 is a block diagram of a POS terminal and a merchandise reading device of the checkout system.

FIG. 3 illustrates a data structure of a PLU file stored in the checkout system.

FIG. 4 is a flowchart of a first merchandise presentation method carried out by the checkout system.

FIG. 5 illustrates a relationship between a calculated feature value and a merchandise ID with respect to an item for sale.

FIG. 6 illustrates an example of a screen displayed on a display unit in which a candidate is displayed in an emphasized manner.

FIG. 7 is a flowchart of a second merchandise presentation method carried out by the checkout system.

FIG. 8 illustrates an example of a screen displayed on the display unit in which a plurality of candidates is displayed with an ordinary size according to the second merchandise presentation method.

FIG. 9 illustrates an example of a screen displayed on the display unit in which a background of an image of a candidate is displayed in a different manner from backgrounds of images of the other candidates.

FIG. 10 illustrates an example of a screen displayed on the display unit in which the image size of the candidates becomes smaller in accordance with similarities of the candidates.

### DETAILED DESCRIPTION

In general, according to one embodiment, a checkout apparatus includes an imaging unit configured to convert an image of an item to be purchased into image data, a processing unit configured to determine one or more items for sale as candidates, based on the generated image data and image data of items for sale that have been previously registered, and a display unit configured to display information indicating the one or more candidates. When the processing unit determines as candidates a first candidate that has a first similarity value and a second candidate that has a second similarity value that indicates less similarity than the first similarity value, the display unit displays the information indicating the first candidate and the information indicating the second candidate in a same format if a difference between the first and second similarity values is smaller than a predetermined value, and in different formats if the difference is greater than the predetermined value.

Hereinafter, a description will be given about a check-out system according to the embodiment.

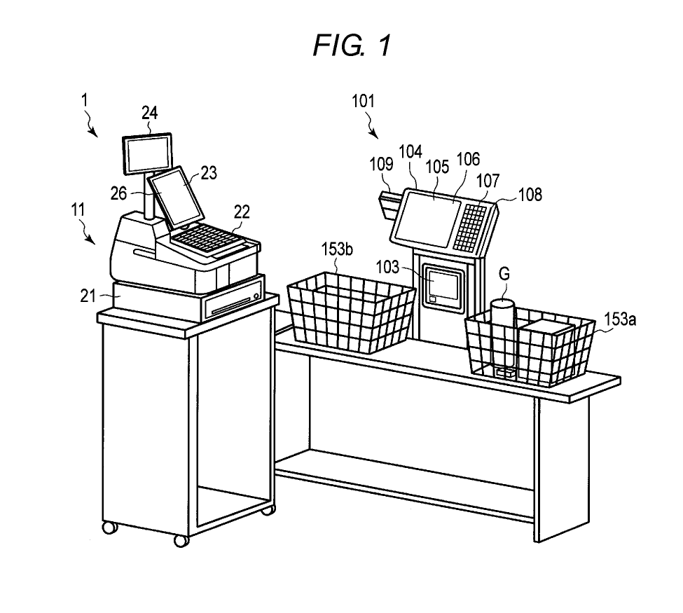

FIG. 1 illustrates a check-out system (POS system) 1.

As illustrated in FIG. 1, the check-out system 1 includes a merchandise reading device 101 which generates image data of items to be purchased and a POS terminal 11 which carries out a checkout processing for items purchased in one transaction.

In the embodiment, the merchandise reading device 101 performs information processing of executing a merchandise presentation method according to the embodiment. Alternatively, the merchandise reading device 101 and the POS terminal 11 may share and perform the processing relating to the merchandise presentation method according to the embodiment.

The POS terminal 11 includes a drawer 21, a keyboard 22, a display device 23, a display device 24 for a customer, and the like. The display surface of the display device 23 is provided with a touch panel 26, and it is possible to perform an input from the touch panel 26 to the POS terminal 11.

The merchandise reading device 101 is connected to the POS terminal 11 so as to communicate each other. In addition, a reading window 103 and a display and operation unit 104 are included in the merchandise reading device 101.

The display and operation unit 104 has a display device 106 as a display unit with a touch panel 105 laminated thereon. At a right position next to the display device 106, a keyboard 107 is disposed. At a right position next to the keyboard 107, a card reading groove 108 for a card reader, which is not illustrated in FIG. 1, is provided. On a back left side of the display and operation unit 104 when viewed from an operator side, a display device 109 for a customer, which is for providing the customer with information, is installed.

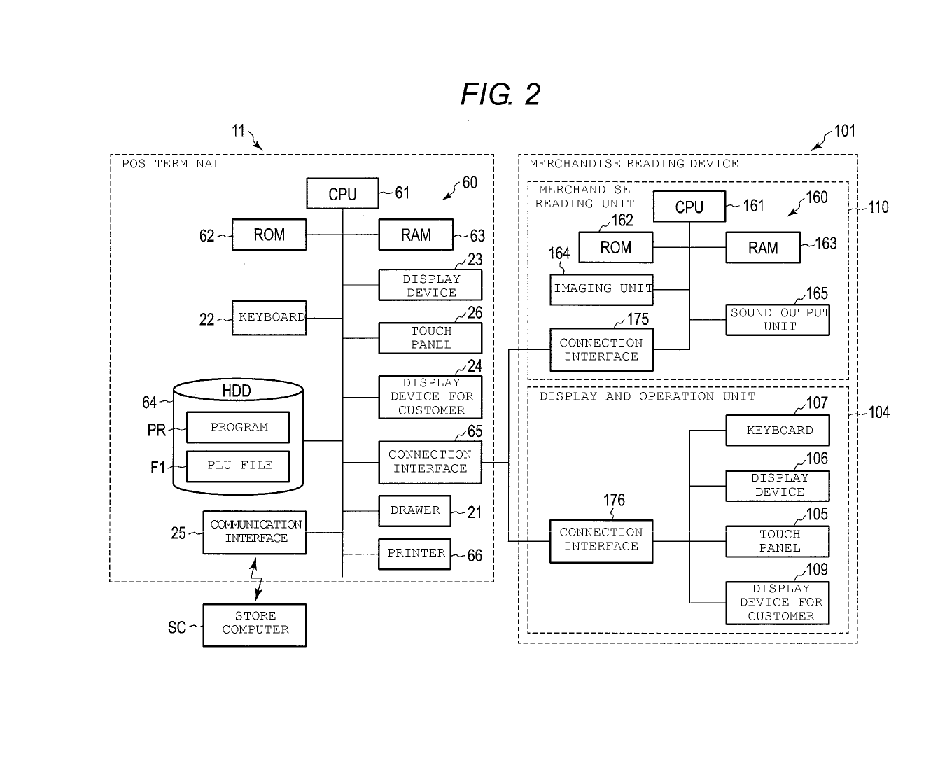

The merchandise reading device 101 as described above has a merchandise reading unit 110 (see FIG. 2). In the merchandise reading unit 110, an imaging unit 164 (see FIG. 2) is disposed behind the reading window 103. In a first shopping basket 153a which is brought by a customer, an item G to be purchased in one transaction is accommodated. The item G in the first shopping basket 153a is moved to a second shopping basket 153b by an operator of the merchandise reading device 101. In the course of moving the item G, the item G is moved towards the reading window 103 of the merchandise reading device 101. At this time, the imaging unit 164 (see FIG. 2) disposed behind the reading window 103 images the item G.

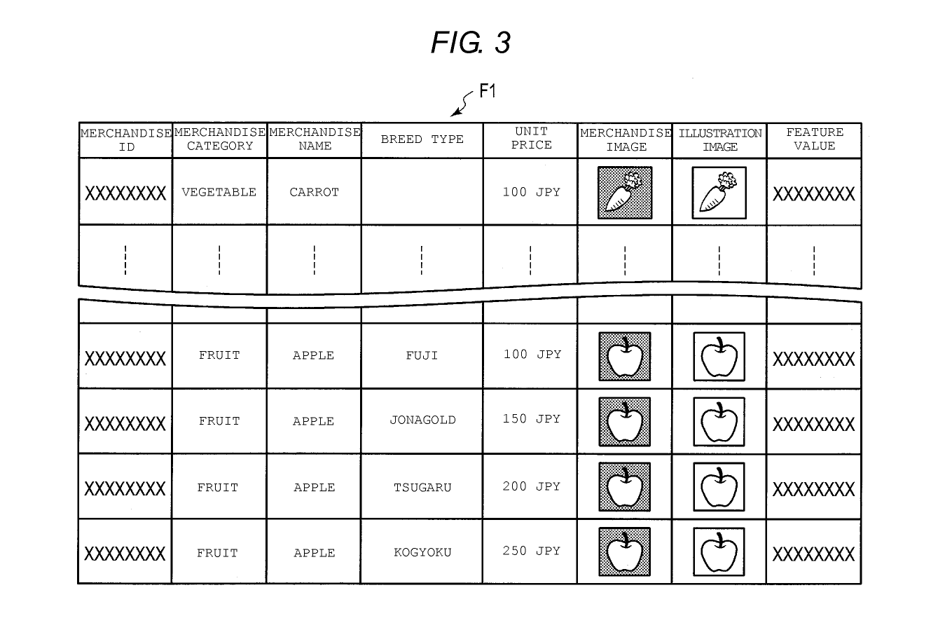

The merchandise reading device 101 displays, on the display and operation unit 104, a screen for designating which of items registered in a PLU file F1 (see FIG. 3) the item G included in the image captured by the imaging unit 164 corresponds to. The screen is displayed in accordance with the merchandise presentation method according to the embodiment. Then, the merchandise reading device 101 provides a merchandise code of the designated item to the POS terminal 11.

The POS terminal 11 records information relating to sales registration, such as a merchandise category of the item corresponding to a merchandise ID, a merchandise name, and a unit price based on the merchandise ID provided by the merchandise reading device 101 in a sales master file (not illustrated) or the like and performs sales registration.

FIG. 2 is a block diagram of the POS terminal 11 and the merchandise reading device 101. The POS terminal 11 includes a microcomputer 60 as an information processing unit which executes information processing. The microcomputer 60 is configured such that a read only memory (ROM) 62 and a random access memory (RAM) 63 are connected to a central processing unit (CPU) 61, which executes various kinds of calculation processing and controls the respective components, via a bus.

All of the drawer 21, the keyboard 22, the display device 23, the touch panel 26, and the display device 24 for a customer are connected to the CPU 61 in the POS terminal 11 via various input and output circuits (all of which are not illustrated in the drawing). These components are controlled by the CPU 61.

A hard disk drive (HDD) 64 is connected to the CPU 61 in the POS terminal 11. The HDD 64 stores programs and various files. The programs and various files stored in the HDD 64 are entirely or partially copied to the RAM 63 and are executed by the CPU 61 at the time of activating the POS terminal 11. One example of the programs stored in the HDD 64 is a program PR for merchandise sales data processing. One example of the files stored in the HDD 64 is a PLU file F1 which is distributed from a store computer SC and stored thereon.

The PLU file F1 is used as a dictionary and is a merchandise file in which a relation between information relating to sales registration of an item for sale and an image of the item is set for each of items for sale.

FIG. 3 illustrates an example of a data structure of the PLU file F1. As illustrated in FIG. 3, the PLU file F1 is a file in which information relating to an item, such as a uniquely allocated merchandise ID, a merchandise category to which the item belongs, a merchandise name, and a unit price, a merchandise image (reference image) of the item that is previously obtained, an illustration image of the item G, a feature value such as a color tone, surface unevenness or the like, read from the image or the reference image are stored for each item for sale as merchandise information of the item. In addition, the feature value is used for similarity determination which will be described later. Moreover, the PLU file F1 is configured so as to be able to be read by the merchandise reading device 101 via a connection interface 65.

If it is necessary to recognize (detect) not only a category of the product (merchandise) but also a breed type, the feature value and the like are managed for items of each breed type in the PLU file F1. According to the embodiment, the information relating to the item such as a merchandise name and a unit price, the merchandise image (reference image) of the item, the illustration image which represents the item, and the feature value are managed for each breed type as illustrated in FIG. 3.

For example, if the category of the product (item) is an “apple,” the information relating to the product such as a merchandise name and a unit price, the merchandise image (reference image) of the product, the illustration image which represents the product, and the feature value are managed for each of breed type such as “Fuji,” “Jonagold,” “Tsugaru,” and “Kogyoku.”

Returning to FIG. 2, a communication interface 25 for executing data communication with the store computer SC is connected to the CPU 61 in the POS terminal 11 via an input and output circuit (not illustrated). The store computer SC is located in a back office of the store. The PLU file F1 that can be transmitted to the POS terminal 11 is stored in an HDD (not illustrated) of the store computer SC.

Furthermore, the connection interface 65 which enables data exchange with the merchandise reading device 101 is connected to the CPU 61 of the POS terminal 11. The merchandise reading device 101 is connected to the connection interface 65. A printer 66 which performs printing of a receipt and the like is connected to the CPU 61 of the POS terminal 11. The POS terminal 11 is controlled by the CPU 61 to print a receipt for one transaction.

The merchandise reading device 101 also includes a microcomputer 160. The microcomputer 160 is configured such that a ROM 162 and a RAM 163 are connected to a CPU 161 via a bus. The ROM 162 stores a program for causing the CPU 161 to execute the merchandise presentation method according to the embodiment.

The RAM 163 is used as a working area for executing the merchandise presentation method according to the program. For example, a feature value calculated for each item is associated with a merchandise ID and stored. In addition, the program for executing the merchandise presentation method according to the embodiment is not limited to a program stored in the ROM 162. For example, the program may be stored in the HDD 64 in the POS terminal 11 or may be stored in an external storage device (an HDD, a USB, or the like).

An imaging unit 164 and a sound output unit 165 are connected to the CPU 161 via various input and output circuits (all of which are not illustrated in the drawing). Operations of the imaging unit 164 and the sound output unit 165 are controlled by the CPU 161. The display and operation unit 104 is connected to the merchandise reading unit 110 and the POS terminal 11 via a connection interface 176. Operations of the display and operation unit 104 are controlled by the CPU 161 in the merchandise reading unit 110 and the CPU 61 in the POS terminal 11.

The imaging unit 164 is a color CCD image sensor, a color CMOS image sensor, or the like and is an imaging section for capturing an image through the reading window 103 under control of the CPU 161. For example, the imaging unit 164 captures a moving image at a frame rate of 30 fps (frames per second). Each of the frame images (captured image) sequentially captured at a predetermined frame rate by the imaging unit 164 is saved in the RAM 163.

The sound output unit 165 includes a sound circuit for generating alert sound or the like that is set in advance and a speaker. The sound output unit 165 provides information by the alert sound or other sound under control of the CPU 161.

Furthermore, a connection interface 175, which is connected to the connection interface 65 in the POS terminal 11 and enables data exchange with the POS terminal 11, is connected to the CPU 161. In addition, the CPU 161 exchanges data with the display and operation unit 104 via the connection interface 175.

Next, a description will be given with respect to the merchandise presentation method according to the embodiment.

The merchandise presentation method according to the embodiment is achieved by the CPU 161 of the merchandise reading device 101 executing the program stored in the ROM 162. However, the CPU 61 in the POS terminal 11 may perform a part of the processing.

### <First Merchandise Presentation Method>

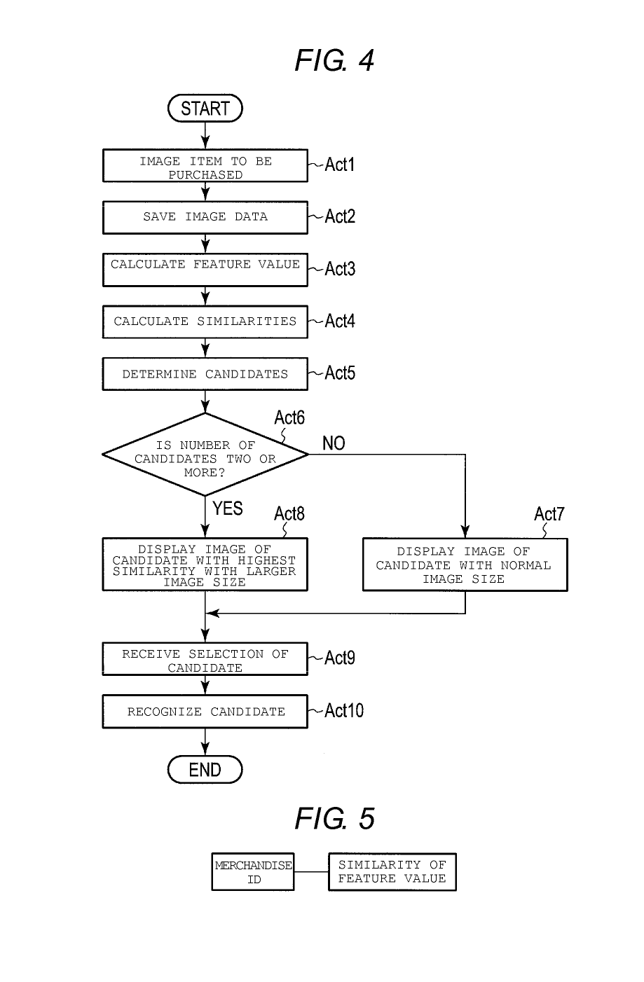

FIG. 4 is a flowchart of a first merchandise presentation method carried out by the check-out system.

When an operator holds an item to be purchased near the reading window 103, the imaging unit 164 images the item (Act1). Image data generated by the imaging unit 164 is saved in the RAM 163 (Act2).

The CPU 161 calculates a feature value from color information and texture information of the image data saved in Act2 (Act3). In addition, the calculation of the feature value from the image data is based on a technology which is generally used for a check-out system.

Next, the CPU 161 compares feature values of items for sale, each having a merchandise ID, with the feature value calculated in Act3 with reference to the PLU file F1 stored in the HDD 64 of the POS terminal 11, and calculates similarities between the feature value of the imaged item and the feature values of the items for sales having the merchandise IDs (Act4). Each of the calculated similarities are associated with the corresponding merchandise ID and stored in the RAM 163 as illustrated in FIG. 5. In addition, the calculated similarities may be stored in the HDD 64 of the POS terminal 11.

Among the similarities between the feature value of the imaged item and the feature values of the items having the merchandise IDs, which are calculated in Act4, items (merchandise IDs) with similarities which exceed a predetermined threshold value (predetermined similarity) are determined as candidates (Act5). If there is no item with a similarity which exceeds the predetermined threshold value (predetermined similarity), error processing is performed, and the operator directly inputs the item to be purchased.

Next, it is determined whether or not the number of the candidates determined in Act5 is two or more (Act6). If the number of the candidates is not two or more (i.e., one), an image of the candidate that has an ordinary size is displayed on the display device 106 (Act7).

In contrast, if the number of candidates is two or more, an image of a candidate with the highest similarity among the candidates that are determined in Act5 is displayed on the display device 106 with a larger image size (Act8). By such an operation, it is possible to display the image of the candidate with the highest similarity in an emphasized manner.

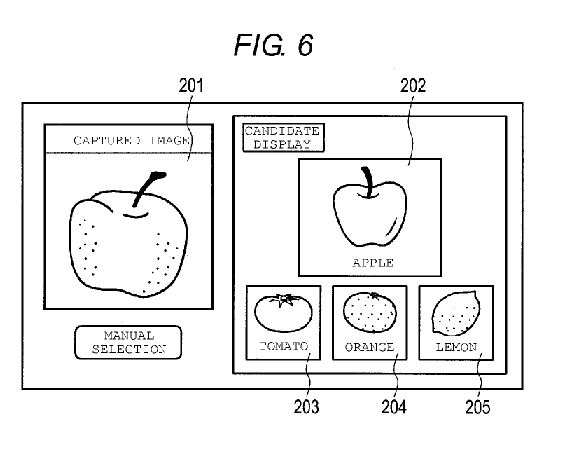

FIG. 6 illustrates an example of a screen of the display device 106 in which a candidate is displayed in an emphasized manner according to a first merchandise presentation method.

As illustrated in FIG. 6, an icon image 201 of an imaged item is displayed, and an icon image 202 of an “apple” as a candidate with the highest similarity among the candidates is displayed with a larger image size, on the display device 106. An icon image 203 of a “tomato” as another candidate, an icon image 204 of an “orange,” and an icon image 205 of a “lemon” are displayed with a normal image size.

The images of the candidates are created by the CPU 161 based on “merchandise images” associated with the candidates (merchandise IDs) in the PLU file F1. For example, the CPU 161 performs processing of increasing the size of the “merchandise image” in the PLU file F1 and creates the image of the candidate with the highest similarity. Alternatively, images with different sizes may be prepared in advance, and the CPU 161 may select one of the images prepared in advance in accordance with the similarity of the candidate.

After the processing in Act7 or Act8, the CPU 161 receives operator's selection of a candidate among the candidates displayed on the display device 106 through a touch panel 105 (Act9) and recognizes the candidate (merchandise ID) (Act10).

Therefore, according to the first merchandise presentation method, it is possible to emphasize a candidate with the highest similarity by displaying the image of the candidate with a larger image size than images of the other candidates. According to such a configuration, the operator may be lead to select the candidate which is displayed in the emphasized manner.

### <Second Merchandise Presentation Method>

A correct recognition rate of the merchandise recognition technique is not always 100%. Therefore, there is also a possibility that the candidate with the highest similarity is not always equal to an item to be purchased, which is a correct answer. According to a second merchandise presentation method, it is possible to more accurately determine a candidate as a target of the emphasized display than the first merchandise presentation method.

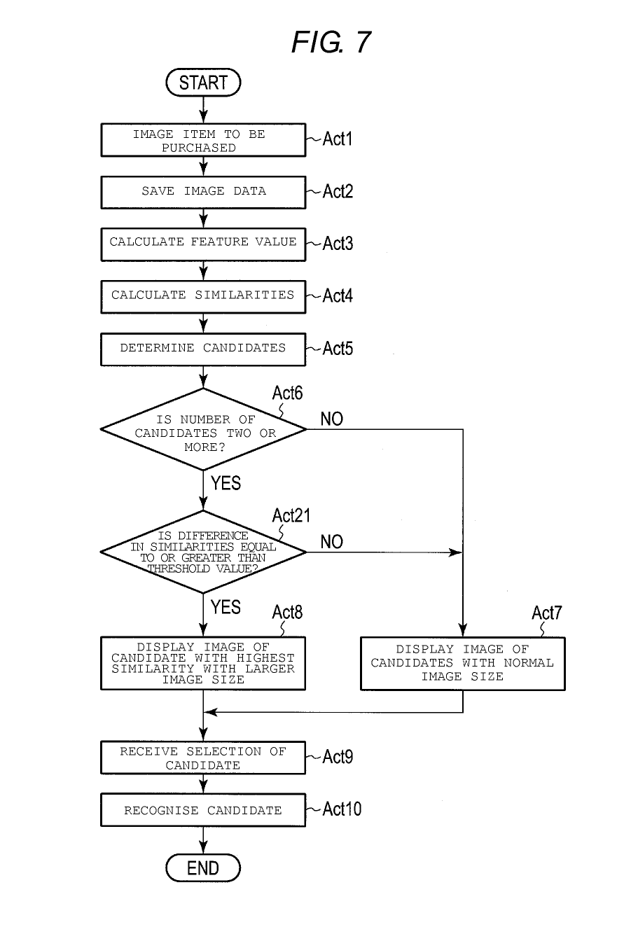

FIG. 7 is a flowchart of the second merchandise presentation method carried out by the check-out system.

Since the operations in Act1 to Act10 are the same as those in the first merchandise presentation method described above, the description thereof will be omitted here. According to the second merchandise presentation method, an operation in Act21 is performed if it is determined in Act6 that the number of candidates is two or more.

In Act21, a difference in similarities between the item to be purchased and the plurality of candidates is determined. Specifically, a difference between the highest similarity and the second highest similarity among the plurality of similarities calculated in Act4 is obtained with respect to the plurality of candidates determined in Act5. Then, it is determined whether or not the obtained difference in similarities exceeds a predetermined threshold value.

If it is determined in Act21 that the difference in similarities exceeds the predetermined threshold value, the processing proceeds to Act8 in order to display an image of the candidate with the highest similarity in the emphasized manner because a possibility that the candidate with the highest similarity is the item to be purchased is high.

On the other hand, if it is determined in Act21 that the difference in similarities does not exceed the predetermined threshold value, the processing proceeds to Act7 in order to display images of the plurality of candidates determined in Act5 with a normal size because the possibility that the candidate with the highest similarity is the item to be purchased is low.

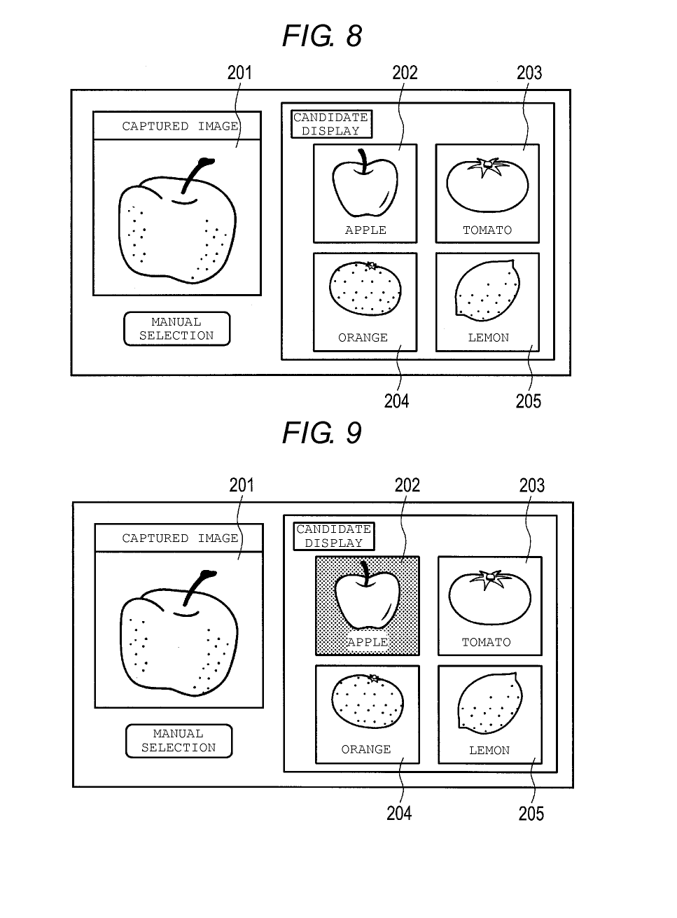

FIG. 8 illustrates an example of a screen displayed on the display device 106 in which a plurality of candidates are displayed with a normal size according to the second merchandise presentation method.

As illustrated in FIG. 8, the icon image 201 of the imaged item is displayed, and all of the icon image 202 of the “apple” with the highest similarity, the icon image 203 of the “tomato” the icon image 204 of the “orange”, and the icon image 205 of the “lemon,” are all displayed with a normal size on the display device 106.

Therefore, according to the second merchandise presentation method, it is possible to more accurately determine a candidate to be displayed in the emphasized manner, as compared with the first merchandise presentation method. In addition, if a possibility that the emphasized candidate is the item to be purchased is low, it is possible to display the candidate with the highest similarity without emphasizing it and rather display the candidate in the same manner as the other candidates. With such a configuration, it is possible to effectively lead the operator to not select an erroneous candidate due to erroneously displaying the erroneous candidate.

Although a size of an image of a candidate is increased for emphasizing the candidate according to the aforementioned first and second merchandise presentation methods, the embodiments are not limited thereto. Various displaying methods for emphasizing the candidate may be carried out.

As illustrated in FIG. 9, for example, emphasized display may be performed by differentiating a background of an image of a candidate as a target of the emphasized display from backgrounds of images of the other candidates.

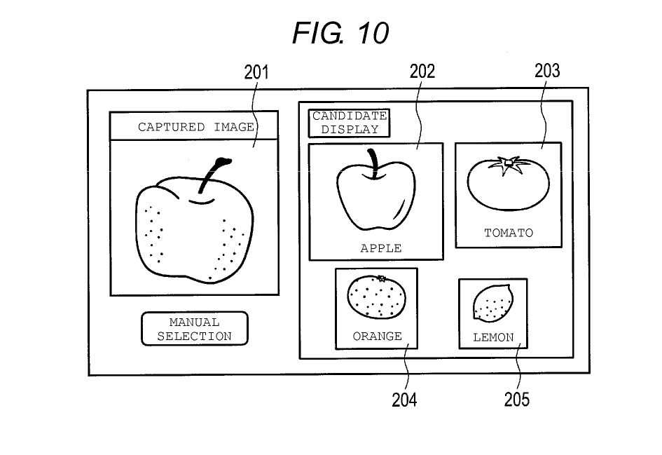

In addition, only an image of a candidate with the highest similarity is emphasized according to the aforementioned first and second merchandise presentation methods. Alternatively, methods of the emphasized display may be by differentiating the icons as the similarities of the candidates changes. As illustrated in FIG. 10, for example, the icon image 202 of the “apple” as the candidate with the highest similarity, the icon image 203 of the “tomato” as the candidate with the second highest similarity, the icon image 204 of the “orange” as the candidate with the third highest similarity, and the icon image 205 of the “lemon” with the fourth highest similarity may be displayed with a smaller size in as the similarity decreases.

A subject which executes the operation is a subject relating to a computer such as hardware, a composite body of hardware and software, software, or software being executed. Although examples of the subject which carries out the operation include a combination of a process executed on a processor, the processer, an object, an execution file, a thread, a program, and a computer, the embodiments are not limited thereto. For example, an information processing apparatus or an application which is executed by the information processing apparatus is also applicable as the subject. A process or a thread may be caused to function as a plurality of subjects which execute the operations. The subject which executes the operation may be provided in a single information processing apparatus or may be divided into a plurality of information processing procedures.

The aforementioned functions may be recorded in the apparatus in advance, the same functions may be downloaded to the apparatus from a network, or the same functions stored in a recording medium may be installed in the apparatus. A recording medium with any configuration may be used as long as the recording medium may store a program as a disc ROM, a memory card, or the like and may be read by the apparatus. In addition, the functions obtained by being installed or downloaded in advance as described above may be achieved in cooperation with an operating system (OS) or the like in the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A checkout apparatus comprising:
an imaging unit configured to convert an image of an item to be purchased into image data;
a processing unit configured to determine one or more items for sale as candidates, based on the generated image data and image data of items for sale that have been previously registered; and
a display unit configured to display information indicating the one or more candidates, wherein
when the processing unit determines as candidates a first candidate that has a first similarity value that indicates the highest similarity to the item to be purchased and a second candidate that has a second similarity value that indicates the second highest similarity to the item to be purchased,
the display unit displays the information indicating the first candidate and the information indicating the second candidate in a same format if a difference between the first and second similarity values is smaller than a predetermined value, and in different formats if the difference is greater than the predetermined value.

2. The checkout apparatus according to claim 1, wherein
the information indicating the first and second candidates includes images thereof, and
the format is an image size of the first and second candidates.

3. The checkout apparatus according to claim 1, wherein
the information indicating the first and second candidates includes images thereof, and
the format is a background style of the images of the first and second candidates.

4. The checkout apparatus according to claim 1, wherein
the processing unit determines that the item for sale is a candidate, when a similarity value of the item for sale is greater than a predetermined value.

5. (canceled)

6. The checkout apparatus according to claim 1, wherein
the processing unit determines as a third candidate an item for sale that has a third similarity value that indicates less similarity than the second similarity value, and
the display unit displays the information indicating the third candidate.

7. The checkout apparatus according to claim 6, wherein
the display unit displays the information indicating the third candidate in a same format as the information indicating the second candidate.

8. The checkout apparatus according to claim 6, wherein
the display unit displays the information indicating the third candidate in a format different from the format for the information indicating the second candidate.

9. A method for presenting candidates for an item to be purchased, the method comprising:
converting, at an imaging unit, an image of an item to be purchased into image data;
determining as a first candidate an item for sale that has a first similarity value that indicates the highest similarity to the item to be purchased and as a second candidate an item for sale that has a second similarity values that indicates the second highest similarity to the item to be purchased, based on the generated image data and image data of items for sale that have been previously registered; and
displaying, on a display unit, first information indicating the first candidate and second information indicating the second candidate, wherein
the first information and the second information are displayed in a same format, if a difference between the first and second similarity values is smaller than a predetermined value, and
the first information and the second information are displayed in different formats, if the difference is greater than the predetermined value.

10. The method according to claim 9, wherein
the information indicating the first and second candidates includes images thereof, and
the format is an image size of the first and second candidates.

11. The method according to claim 9, wherein
the information indicating the first and second candidates includes images thereof, and
the format is a background style of the images of the first and second candidates.

12. The method according to claim 9, wherein
the first candidate is determined when the first similarity value is greater than a predetermined value, and the second candidate is determined when the second similarity value is greater than the predetermined value.

13. (canceled)

14. The method according to claim 9, further comprising:
determining as a third candidate an item for sale that has a third similarity value that indicates less similarity than the second similarity value; and
displaying information indicating the third candidate.

15. The method according to claim 14, wherein
the information indicating the third candidate is displayed in a same format as the information indicating the second candidate.

16. The method according to claim 14, wherein
the information indicating the third candidate is displayed in a format different from the format for the information indicating the second candidate.

17. A non-transitory computer readable medium comprising a program that is executable in a computing device to cause the computing device to perform a method for presenting one or more candidates for an item to be purchased, the method comprising:
controlling an imaging unit to convert an image of an item to be purchased into image data thereof;
determining as a first candidate an item for sale that has a first similarity value that indicates the highest similarity to the item to be purchased and as a second candidate an item for sale that has a second similarity values that indicates the second highest similarity to the item to be purchased, based on the generated image data and image data of items for sale that have been previously registered; and
controlling a display unit to display first information indicating the first candidate and second information indicating the second candidate, wherein
the first information and the second information are displayed in a same format, if a difference between the first and second similarity values is smaller than a predetermined value, and
the first information and the second information are displayed in different formats, if the difference is greater than the predetermined value.

18. The non-transitory computer readable medium according to claim 17, wherein
the information indicating the first and second candidates includes images thereof, and
the format is an image size of the first and second candidates.

19. The non-transitory computer readable medium according to claim 17, wherein
the information indicating the first and second candidates includes images thereof, and
the format is a background style of the images of the first and second candidates.

20. The non-transitory computer readable medium according to claim 17, wherein
the first candidate is determined when the first similarity value is greater than a predetermined value, and the second candidate is determined when the second similarity value is greater than the predetermined value.

21. The non-transitory computer readable medium according to claim 17, wherein the method further comprises:
determining as a third candidate an item for sale that has a third similarity value that indicates less similarity than the second similarity value; and
controlling the display unit to display information indicating the third candidate.

22. The non-transitory computer readable medium according to claim 21, wherein
the information indicating the third candidate is displayed in a same format as the information indicating the second candidate.
